(19) United States
(12) Patent Application Publication
(10) Pub. No.: US 2016/0286537 A1
(43) Pub. Date: Sep. 29, 2016

(54) APPARATUSES, COMPUTER READABLE MEDIA, AND METHODS FOR SIGNALING NON-CONTIGUOUS SUB-CHANNELS IN A HIGH-EFFICIENCY WIRELESS LOCAL-AREA NETWORK

(71) Applicant: Intel IP Corporation, Santa Clara, CA (US)

(72) Inventors: Chittabrata Ghosh, Fremont, CA (US); Shahrnaz Azizi, Cupertino, CA (US)

(21) Appl. No.: 14/669,859

(22) Filed: Mar. 26, 2015

(51) Int. Cl. H04W 72/04; H04B 7/04; H04L 5/00

(52) U.S. Cl. CPC H04W 72/044; H04L 5/0007; H04B 7/0452; H04W 72/0413

(57) ABSTRACT

Apparatuses, methods, and computer readable media for resource allocation are disclosed. A high-efficiency wireless local-area network (HEW) master station is disclosed. The HEW master device may include circuitry configured to generate one or more resource allocations for each station of a plurality of stations. Each resource allocation may include an address of a corresponding station, a channel index to indicate a channel of a plurality of pre-defined channels of a bandwidth, and a sub-channel index to indicate the sub-channel bandwidth. If the sub-channel bandwidth is less than 20 MHz, each resource allocation includes a sub-channel location to indicate a sub-channel out of the multiple sub-channels of the indicated sub-channel bandwidth. The one or more resource allocations may be for a transmission opportunity in case of non-contiguous resource allocations for a single station. The circuitry may be further configured to operate in accordance with orthogonal frequency division multiple access (OFDMA).

### BACKGROUND

Embodiments pertain to high-efficiency local-area wireless network (HEW), and some embodiments related to Institute of Electrical and Electronic Engineers (IEEE) 802.11ax. Some embodiments relate to distributed sub-channel allocation. Some embodiments relate to sub-channel allocation for a plurality of HEW stations operating in accordance with orthogonal frequency division multiple-access (OFDMA).

### TECHNICAL FIELD

Wireless devices communicate with one another using a wireless medium. The resources of the wireless medium are often limited and the users of the wireless devices often demand faster communication from the wireless medium.

Moreover, often more than one standard may be in use in a wireless local-area network (WLAN). For example, IEEE 802.11ax, referred to as high-efficiency wireless local-area networks (HEW)(WLAN) may need to be used with legacy versions of IEEE 802.11.

Therefore, there are general needs in the art to improve the operation and/or efficiency of allocating the resources of the wireless medium to the wireless devices.

### BRIEF DESCRIPTION OF THE DRAWINGS

The present disclosure is illustrated by way of example and not limitation in the figures of the accompanying drawings, in which like references indicate similar elements and in which:

FIG. 1 illustrates a wireless network in accordance with some embodiments;

FIG. 2 illustrates a hierarchical structure for signaling a resource allocation in accordance with example embodiments;

FIG. 3 illustrates a resource allocation signaling using the hierarchical structure of FIG. 2 when sub-channels are allocated to stations over multiples of 20 MHz channels in accordance with some embodiments;

FIG. 4 illustrates a resource allocation signaling using the hierarchical structure of FIG. 2 when sub-channels are allocated to stations over multiples of 20 MHz channels in accordance with some embodiments;

FIG. 5 illustrates a top level of a hierarchical structure for signaling a resource allocation in accordance with example embodiments; and

FIG. 6 illustrates a HEW station in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

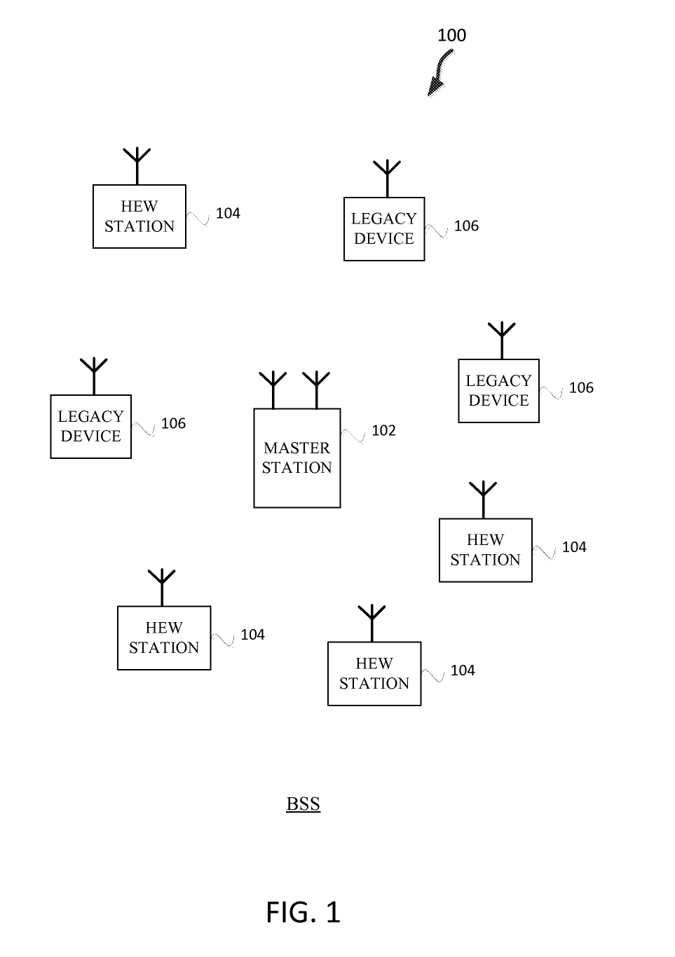

FIG. 1 illustrates a wireless network in accordance with some embodiments. The wireless local-area network (WLAN) may comprise a basic service set (BSS) 100 that may include a master station 102, which may be an access point (AP), a plurality of high-efficiency wireless (HEW) (e.g., IEEE 802.11ax) stations 104 and a plurality of legacy (e.g., IEEE 802.11n/ac) devices 106.

The master station 102 may be an access point (AP) using the 802.11 to transmit and receive. The master station 102 may be a base station. The master station 102 may be a master station. The master station 102 may use other communications protocols as well as the 802.11 protocol. The 802.11 protocol may be 802.11ax. The 802.11 protocol may include using Orthogonal Frequency-Division Multiple Access (OFDMA), time division multiple access (TDMA), and/or code division multiple access (CDMA). The 802.11 protocol may include a multiple access technique. For example, the 802.11 protocol may include space-division multiple access (SDMA) and/or multi-user (MU) multiple-input and multiple-output (MIMO)(MU-MIMO).

The HEW devices 104 may operate in accordance with 802.11ax or another standard of 802.11. The legacy devices 106 may operate in accordance with one or more of 802.11 a/g/ag/n/ac, or another legacy wireless communication standard. The HEW devices 104 may be high efficiency (HE) stations. The legacy devices 106 may be stations.

The HEW devices 104 may be wireless transmit and receive devices such as a cellular telephone, handheld wireless device, wireless glasses, wireless watch, wireless personal device, tablet, or another device that may be transmitting and receiving using the 802.11 protocol such as 802.11ax or another wireless protocol.

The BSS 100 may operate on a primary channel and one or more secondary channels or sub-channels. The BSS 100 may include one or more APs 102. In accordance with embodiments, the master station 102 may communicate with one or more of the HEW devices 104 on one or more of the secondary channels or sub-channels or the primary channel. A sub-channel may be a portion of a channel or bandwidth. A sub-channel may have a minimum number of tones such as 26 tones, which corresponds to a portion of the bandwidth. In example embodiments, the master station 102 communicates with the legacy devices 106 on the primary channel. In example embodiments, the master station 102 may be configured to communicate concurrently with one or more of the HEW devices 104 on one or more of the secondary channels and a legacy device 106 utilizing only the primary channel and not utilizing any of the secondary channels.

The master station 102 may communicate with legacy devices 106 in accordance with legacy IEEE 802.11 communication techniques. In example embodiments, the master station 102 may also be configured to communicate with HEW devices 104 in accordance with legacy IEEE 802.11 communication techniques. Legacy IEEE 802.11 communication techniques may refer to any IEEE 802.11 communication technique prior to IEEE 802.11ax.

In some embodiments, a HEW frame may be configurable to have the same bandwidth and the bandwidth may be one of 20 MHz, 40 MHz, or 80 MHz, 160 MHz, 320 MHz contiguous bandwidths or an 80+80 MHz (160 MHz) non-contiguous bandwidth. In some embodiments, bandwidths of 1 MHz, 1.25 MHz, 2.0 MHz, 2.5 MHz, 4 MHz, 5 MHz, 8 MHz, 10 MHz, and 16 MHz, or a combination thereof, may also be used. In some embodiments a different bandwidth less than 320 MHz may be used. A HEW frame may be configured for transmitting a number of spatial streams.

In other embodiments, the master station 102, HEW device 104, and/or legacy device 106 may also implement different technologies such as CDMA2000, CDMA2000 1×, CDMA2000 EV-DO, Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), BlueTooth®, or other technologies.

In example embodiments, if the master station 102 transmits a beacon only on a primary channel, then the HEW devices 104 and legacy devices 106 need to receive the beacon on the primary channel every multiple of a beacon interval (it could be every beacon interval or every 10th beacon or etc.) to maintain their synchronization with the system (e.g. master station 102).

In an OFDMA system (e.g. 802.11ax), an associated HEW device 104 may operate on a subchannel, which may be 20 MHz, of the BSS 100 (that can operate, for example, at 80 MHz). The HEW device 104 may enter a power save mode, and upon coming out of power save mode, the HEW device 104 may need to re-synchronize with BSS 100 by receiving a beacon. If a beacon is transmitted only on the primary channel, then HEW device 104 needs to move and tune to the primary channel, upon waking up, to be able to receive beacons. Then the HEW device 104 needs to re-tune to its operating subchannels, which may be 20 MHz, or it has to follow a handshake procedure to let master station 102 know of a new operating subchannel. The HEW device 104 may risk losing some frames during the channel switch, in example embodiments.

In example embodiments, the HEW device 104 and/or the master station 102 are configured to perform the functions described in conjunction with FIGS. 1-6 such as generating resource allocation signaling, transmitting resource allocation information to HEW stations 104, and operating in accordance with the assigned resource. A resource may be a portion of the wireless medium. For example, a resource may be a portion of the bandwidth such as a sub-channel for a period of time. In example embodiments, a resource may be a spatial stream.

Some embodiments relate to high-efficiency wireless communications including high-efficiency Wi-Fi/WLAN and high-efficiency wireless (HEW) communications. In accordance with some IEEE 802.11ax (High-Efficiency Wi-Fi (HEW)) embodiments, an master station 102 may operate as a master station which may be arranged to contend for a wireless medium (e.g., during a contention period) to receive exclusive control of the medium for an HEW control period (i.e., a transmission opportunity (TXOP)). The master station 102 may transmit an HEW master-sync transmission at the beginning of the HEW control period. The master station 102 may transmit a time duration of the TXOP. During the HEW control period, HEW devices 104 may communicate with the master station 102 in accordance with a non-contention based multiple access technique. This is unlike conventional WLAN communications in which devices communicate in accordance with a contention-based communication technique, rather than a multiple access technique. During the HEW control period, the master station 102 may communicate with HEW stations 104 using one or more HEW frames. During the HEW control period, legacy stations refrain from communicating. In some embodiments, the master-sync transmission may be referred to as an HEW control and schedule transmission.

In some embodiments, the multiple-access technique used during the HEW control period may be a scheduled orthogonal frequency division multiple access (OFDMA) technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique.

The master station 102 may also communicate with legacy stations 106 in accordance with legacy IEEE 802.11 communication techniques. In some embodiments, the master station 102 may also be configurable to communicate with HEW stations 104 outside the HEW control period in accordance with legacy IEEE 802.11 communication techniques, although this is not a requirement.

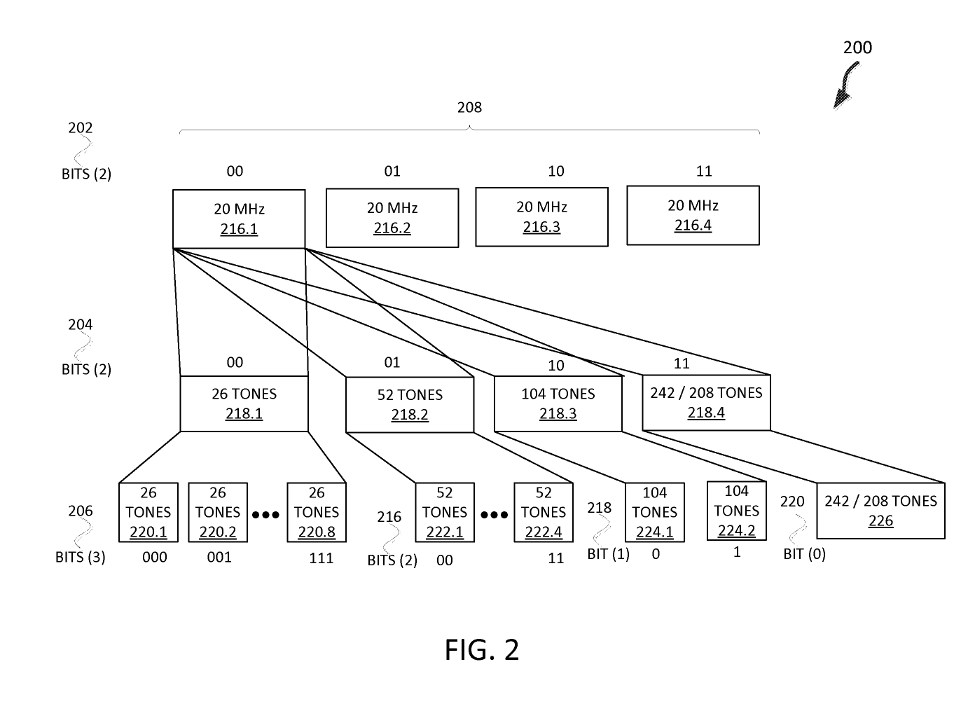

FIG. 2 illustrates a hierarchical structure 200 for signaling a resource allocation, in accordance with example embodiments. Illustrated in FIG. 2 are a bandwidth 208, a channel index 202, a sub-channel index 204, and a sub-channel location 206, 216, 218, 220. The bandwidth 208 may be 80 MHz. In some embodiments, the bandwidth 208 may 160 MHz, 320 MHz, or another number. The channel index 202 may be two bits to indicate which one of four 20 MHz channels 216 of the bandwidth 208 are part of the resource allocation. For example, a channel index 202 of 00 may indicate the first 20 MHz 216.1 of the bandwidth 208, 01 may indicate the second 20 MHz 216.2 of the bandwidth 208, 10 may indicate the third 20 MHz 216.3 of the bandwidth 208, and 11 may indicate the forth 20 MHz 216.4 of the bandwidth. In example embodiments, a different number of bits may be used to indicate the channel 216. For example, if the bandwidth 208 is 160 MHz, the number of bits may be three. As another example, if channels 216 are 40 MHz and the bandwidth 208 is 320 MHz, then 3 bits would be used for the number of bits 210.

The sub-channel index 204 may be two bits to indicate the bandwidth of the sub-channels 220, 222, 224, 226 of the channel. For example, the sub-channel index 204 may be 00 to indicate the channel 216 is divided into eight sub-channels 220, each of bandwidth equivalent to 26 tones. 01 may indicate the channel 216 is divided into four sub-channels 222 each of bandwidth equivalent to 52 tones. 10 may indicate the channel 216 is divided into two sub-channels 224 each of bandwidth equivalent to 104 tones, 11 may indicate the channel 216 is divided into one sub-channels 226 of 242 or 208 tones each. The sub-channel index 204 may be a different number of bits to indicate a different number of sub-channels 220, 222, 223, 226 of the channel 216.

The sub-channel location 206, 216, 218, 220 may be represented with three bits 206, two bits 216, one bit 218, or zero bits 220. For example, a resource allocation 200 with a channel index 202 of 00, a sub-channel index 204 of 00, and a sub-channel location 206 of 001, which is three bits, indicates the sub-channel 220.2 of bandwidth equivalent to 26 tones out of eight sub-channels 220 in the first 20 MHz 216.1. The sub-channel location 206, 216, 218, 220 may be a different number of bits to indicate which sub-channel 220, 222, 224, 226 of the channel 216 is part of the resource allocation 200.

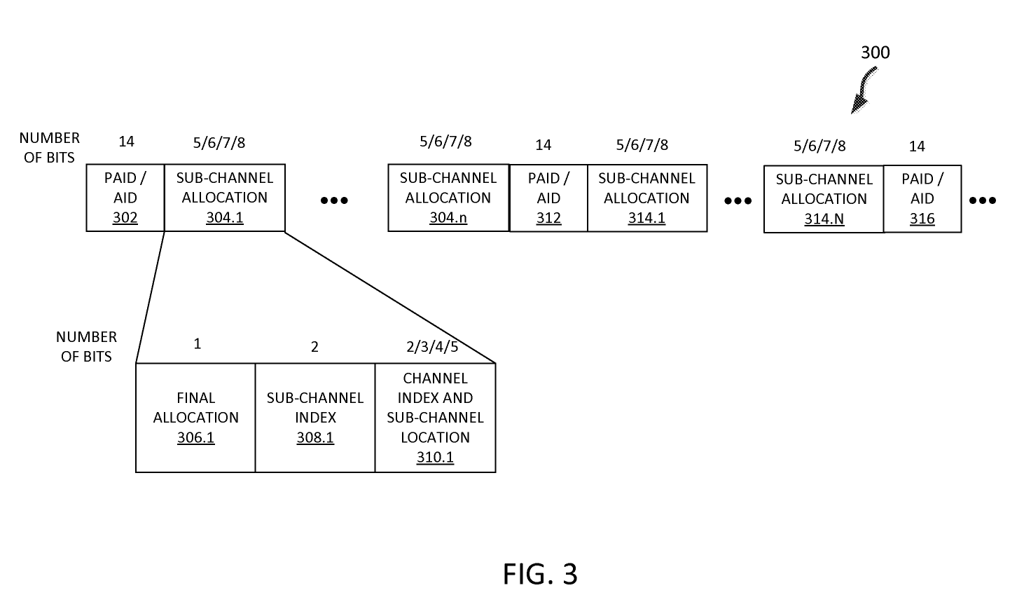

FIG. 3 illustrates a resource allocation signaling 300 using the hierarchical structure 200 of FIG. 2 when sub-channels are allocated to stations over multiples of 20 MHz channels, in accordance with some embodiments. Illustrated in FIG. 3 is a partial association identification (PAID) or association identification (AID) PAID/AID 302, sub-channel allocation 304.1 through sub-channel allocation 304.N, paid/aid 312, sub-channel allocation 314.1 through sub-channel allocation 314.N, and PAID/AID 316.

The PAID/AID 302, 312, 316 may be a station identifier that may be assigned to the station when the station associates with an AP such as a HEW AP 102. The station may be a HEW station 104.

The sub-channel allocation 304.1 may be a sub-channel allocation for the station with the PAID/AID 302. The sub-channel allocation 304.1 may include final allocation 306.1, sub-channel index 308.1, channel index and sub-channel location 310.1. The final allocation 306.1 may be an indication of whether there is another sub-channel allocation 304 after sub-channel allocation 304.1 for the same station. For example, the final allocation 306.1 may be zero indicating that there is another sub-channel allocation 304.2 for the station identified by PAID/AID 302. The sub-channel index 308.1 may be the sub-channel index 204 (FIG. 2). For example, the sub-channel index 308.1 may indicate the number of sub-channels 220, 222, 224, 226 in the channel 216. The sub-channel index 308.1 may be, for example, 10 to indicate that there are two sub-channels 224.1, 224.2 in the channel 216. The sub-channel index 308.1 may be the same size as sub-channel index 204 such as two bits.

The channel index and sub-channel location 310.1 may include a channel index 202 and a sub-channel location 206. In example embodiments, the channel index and sub-channel location 310.1 may be two, three, four, or five bits. The channel index and sub-channel location 310.1 may be two bits if the sub-channel index 308.1 indicates that there is only one sub-channel in the channel 216. For example, sub-channel index 204 (of FIG. 2) with a value of 11 indicates that the channel 216 has only one sub-channel 226. In this example, the channel index and sub-channel location 310.1 may have a value of 00, 01, 10, or 11 for channel 216.1, 216.2, 216.3, or 216.4 respectively.

The channel index and sub-channel location 310.1 may be three bits if the sub-channel index 308.1 indicates that there are two sub-channels in the channel 216. For example, sub-channel index 204 with a value of 10 indicates that the channel 216 has two sub-channels 224.1, 224.2. For this example, an example value of the channel index and sub-channel location 310.1 may be 00 (for channel 216.1) and 1 for sub-channel 224.2.

The channel index and sub-channel location 310.1 may be four bits if the sub-channel index 204 indicates that there are four sub-channels in the channel 216. For example, sub-channel index 204 with a value of 01 indicates that the channel 216 has four sub-channels 222. For this example, an example value of the channel index and sub-channel location 310.1 may be 00 (for channel 216.1) and 11 for sub-channel 222.4.

The channel index and sub-channel location 310.1 may have five bits if the sub-channel index 204 indicates that there are eight sub-channels 220 in the channel 216. For example, sub-channel index 204 with a value of 00 indicates that the channel 216 has eight sub-channels 220. For this example, an example value of channel index and sub-channel location 310.1 may be 00 (for channel 216.1) and 001 for sub-channel 220.2.

A different number of bits may be used for channel index and sub-channel location 310.1 if the bandwidth 208 is allocated in a different number of channels 216 and/or a different number of sub-channels 220, 222, 224, 226.

The resource allocation 200 has the technical effect that a station identified by the PAID/AID 302 may be allocated non-contiguous sub-channels 220, 222, 224, 226.

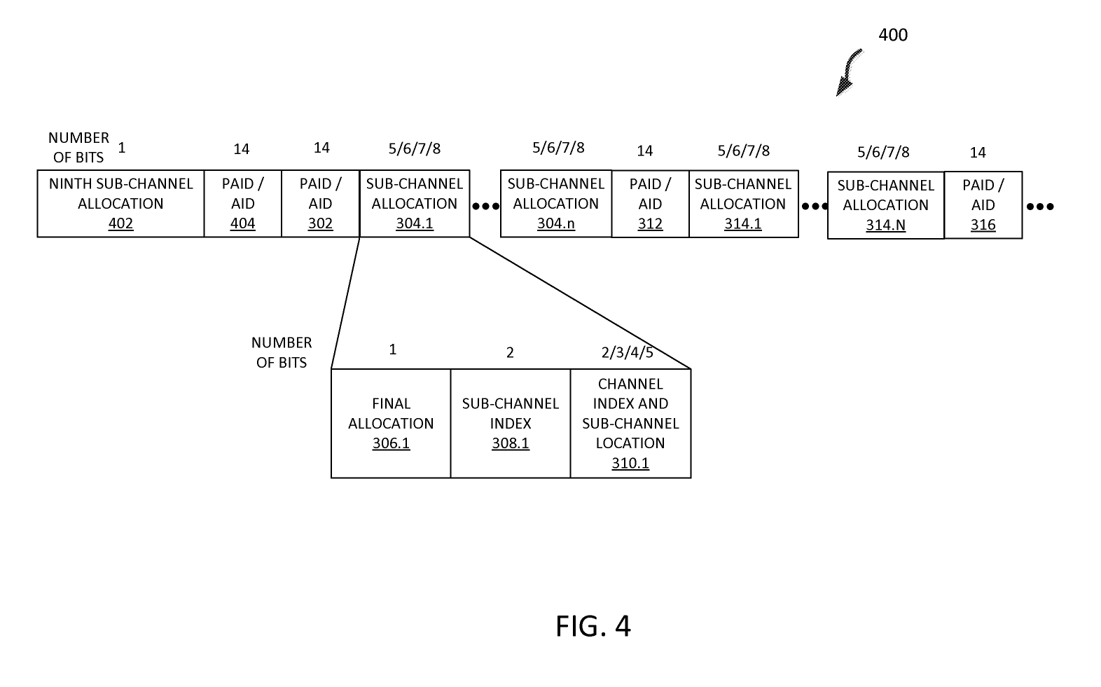

FIG. 4 illustrates a resource allocation 400 signaling using the hierarchical structure 200 of FIG. 2 when sub-channels are allocated to stations over multiples of 20 MHz channels in accordance with some embodiments. Illustrated in FIG. 4 is a ninth sub-channel allocation 402 of bandwidth equivalent to 26 tones, PAID/AID 404, a PAID/AID 302, sub-channel allocation 304.1 through sub-channel allocation 304.N, PAIN/AID 312, sub-channel allocation 314.1 through sub-channel allocation 314.N, and PAID/AID 316.

The ninth sub-channel allocation 402 may be part of the resource allocation 400 to indicate that a ninth sub-channel is allocated to a station with PAID/AID 404. For example, if the ninth sub-channel allocation 402 bit is set to one then it may indicate that the station with the PAID/AID 404 is allocated a sub-channel that does not have a bit representation in sub-channel location 206 or channel index and sub-channel location 301.1. For example, in channel 216.1 there may be 242 tones split into eight sub-channels 220.1 through 220.8, and a ninth sub-channel with 26 tones that may be, for example, in the center of the channel 216.1, towards a left or right edge of the channel 216.1, or spread throughout the channel 216.1. The ninth sub-channel may be predefined. The channel 216 for the ninth sub-channel may be indicated by the first channel index and sub-channel location 310.1 subsequent to the ninth sub-channel indication. In example embodiments, if a ninth sub-channel allocation 402 is indicated, then the station with the PAID/AID 404 may be allocated all ninth sub-channels for each of the channels 216 that includes a ninth channel. In some embodiments, a channel 216 that has only one sub-channel 226 may not have a ninth sub-channel. In some embodiments, none of the channels 216 may have a ninth sub-channel. In some embodiments, if the ninth sub-channel allocation 402 bit is set to zero, then it may indicate that the ninth sub-channel of bandwidth 26 tones is not allocated to a station in this case the following PAID/AID 404 may not be present.

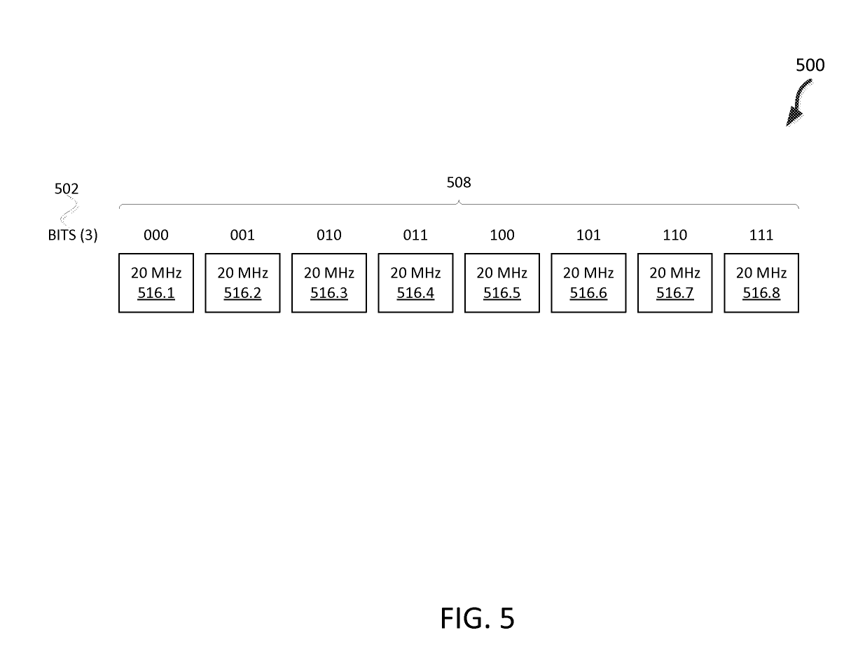

FIG. 5 illustrates a top level of a hierarchical structure 500 for signaling a resource allocation 400 in accordance with example embodiments. Illustrated in FIG. 5 are a bandwidth 508 and a channel index 502. The bandwidth 508 may be 160 MHz. The channel index 502 may be three bits to indicate which one of eight 20 MHz channels 516 of the bandwidth 508 are part of the resource allocation 400. For example, a channel index 502 of 100 may indicate the fifth 20 MHz 516.5 of the bandwidth 508. In example embodiments, a different number of bits may be used to indicate the channel 516. In example embodiments, the sub-channel index 204 and the sub-channel location 206, 216, 218, 220 are indicated in a similar way as in FIG. 2.

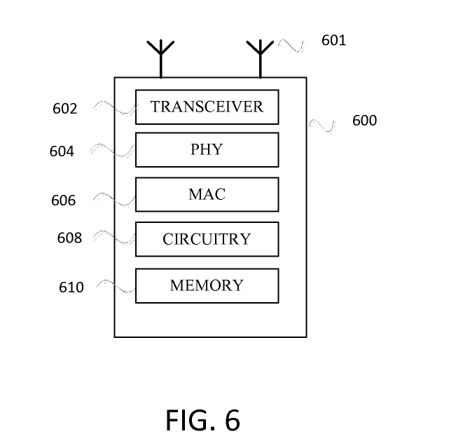

FIG. 6 illustrates a HEW station in accordance with some embodiments. HEW station 600 may be an HEW compliant device that may be arranged to communicate with one or more other HEW stations, such as HEW stations 104 (FIG. 1) or master station 102 (FIG. 1) as well as communicate with legacy devices 106 (FIG. 1). The HEW station 600 may be a master station 102 or access point. HEW stations 104 and legacy devices 106 may also be referred to as HEW devices and legacy stations (STAs), respectively. HEW station 600 may be suitable for operating as access point 102 (FIG. 1) or an HEW station 104 (FIG. 1). In accordance with embodiments, HEW station 600 may include, among other things, a transmit/receive element 601 (for example, an antenna), a transceiver 602, physical layer (PHY) circuitry 604, and medium-access control layer circuitry (MAC) 606. PHY 604 and MAC 606 may be HEW compliant layers and may also be compliant with one or more legacy IEEE 802.11 standards. MAC 606 may be arranged to configure physical protocol data units (PPDUs) and arranged to transmit and receive PPDUs, among other things. HEW station 600 may also include other circuitry 608 and memory 610 configured to perform the various operations described herein. The circuitry 608 may be coupled to the transceiver 602, which may be coupled to the transmit/receive element 601. While FIG. 6 depicts the circuitry 608 and the transceiver 602 as separate components, the circuitry 608 and the transceiver 602 may be integrated together in an electronic package or chip.

In some embodiments, the MAC 606 may be arranged to contend for a wireless medium during a contention period to receive control of the medium for the HEW control period and configure an HEW PPDU. In some embodiments, the MAC 606 may be arranged to contend for the wireless medium based on channel contention settings, a transmitting power level, and a clear channel assessment (CCA) level.

The PHY 604 may be arranged to transmit the HEW PPDU. The PHY 604 may include circuitry for modulation/demodulation, upconversion/downconversion, filtering, amplification, etc. In some embodiments, the circuitry 608 may include one or more processors. The circuitry 608 may be configured to perform functions based on instructions being stored in a RAM or ROM, or based on special purpose circuitry.

In some embodiments, the circuitry 608 may be configured to perform one or more of the functions described herein in conjunction with FIGS. 1-5 generating resource allocations 400, transmitting resource allocations 400 to HEW stations 104, and operating in accordance with the resource allocations 400.

In some embodiments, two or more antennas 601 may be coupled to the PHY 604 and arranged for sending and receiving signals including transmission of the HEW packets. The HEW station 600 may include a transceiver 602 to transmit and receive data such as HEW PPDU and packets that include an indication that the HEW station 600 should adapt the channel contention settings according to settings included in the packet. The memory 610 may store information for configuring the other circuitry 608 to perform operations for configuring and transmitting HEW packets and performing the various operations described herein in conjunction with FIGS. 1-5 such generating resource allocations 400, transmitting resource allocations 400 to HEW stations 104, and operating in accordance with the resource allocations 400.

In some embodiments, the HEW station 600 may be configured to communicate using OFDM communication signals over a multicarrier communication channel. In some embodiments, HEW station 600 may be configured to communicate in accordance with one or more specific communication standards, such as the Institute of Electrical and Electronics Engineers (IEEE) standards including IEEE 802.11-2012, 802.11n-2009, 802.11ac-2013, 802.11ax, DensiFi, standards and/or proposed specifications for WLANs, or other standards as described in conjunction with FIG. 1, although the scope of the disclosed embodiments is not limited in this respect as they may also be suitable to transmit and/or receive communications in accordance with other techniques and standards. In some embodiments, the HEW station 600 may use 4× symbol duration of 802.11n or 802.11ac.

In some embodiments, an HEW station 600 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point 102, a television, a medical device (e.g., a heart rate monitor, a blood pressure monitor, etc.), a base station, a transmit/receive device for a wireless standard such as 802.11 or 802.16, or other device that may receive and/or transmit information wirelessly. In some embodiments, the mobile device may include one or more of a keyboard, a display, a non-volatile memory port, multiple antennas 601, a graphics processor, an application processor, speakers, and other mobile device elements. The display may be an LCD screen including a touch screen.

The antennas 601 may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas 601 may be effectively separated to take advantage of spatial diversity and the different channel characteristics that may result.

Although the HEW station 600 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The following examples pertain to further embodiments. Example 1 is a high-efficiency wireless local-area network (HEW) master station. The HEW master device may include circuitry configured to: generate one or more resource allocations for each station of a plurality of stations. Each resource allocation may include an address of a corresponding station, a channel index to indicate a channel of a plurality of pre-defined channels of a bandwidth, and a sub-channel index to indicate a sub-channel bandwidth within the channel. If the sub-channel bandwidth within the channel is not the entire channel, then each resource allocation may include a sub-channel location to indicate a sub-channel of a plurality of sub-channels of the channel. The circuitry may be further configured to transmit the one or more resource allocations to the plurality of stations. The one or more resource allocations may include a duration. The circuitry may be further configured to receive, in accordance with orthogonal frequency division multiple access (OFDMA) and multi-user multiple-input multiple-output (MU-MIMO), data from the plurality of stations in accordance with the one or more resource allocations.

In Example 2, the subject matter of Example 1 can optionally include where the channel is a 20 MHz portion of the bandwidth, and wherein the bandwidth is one from the following group: 80 MHz, 160 MHz, and 320 MHz.

In Example 3, the subject matter of Examples 1 or 2 can optionally include where the channel index is two bits.

In Example 4, the subject matter of any of Examples 1-3 can optionally include where the sub-channel bandwidth is one from the following group: 26 tones, 52 tones, 104 tones, 242 tones, and 208 tones.

In Example 5, the subject matter of any of Examples 1-4 can optionally include where the sub-channel index is two bits to indicate one of four sub-channel bandwidths.

In Example 6, the subject matter of Example 1 can optionally include where if the sub-channel bandwidth within the channel is not the entire channel, then each sub-channel of the plurality of sub-channels is a multiple of a basic sub-channel size.

In Example 7, the subject matter of Example 6 can optionally include wherein the basic sub-channel size is 26 tones.

In Example 8, the subject matter of any of Examples 1-7 can optionally include where the resource allocation further comprises an indication of whether there is an additional resource allocation for the station.

In Example 9, the subject matter of any of Examples 1-8 can optionally include where the circuitry is further configured to operate in accordance with Institute for Electrical and Electronic Engineers (IEEE) 802.11ax.

In Example 10, the subject matter of any of Examples 1-9 can optionally include where the one or more resource allocations are for a transmission opportunity.

In Example 11, the subject matter of any of Examples 1-10 can optionally include where the one or more resource allocations are part of a high efficiency (HE) signal B field.

In Example 12, the subject matter of any of Examples 1-11 can optionally include where the resource allocation further comprises a ninth sub-channel indication and an additional address of an additional station that is allocated a ninth sub-channel.

In Example 13, the subject matter of any of Examples 1-12 can optionally include memory coupled to circuitry.

In Example 14, the subject matter of Example 13 can optionally include one or more antennas coupled to the circuitry.

Example 15 is a method on a high-efficiency wireless local-area network (HEW) master device. The method may include generating one or more resource allocations for each station of a plurality of stations. Each resource allocation may include an address of a corresponding station, a channel index to indicate a channel of a plurality of pre-defined channels of a bandwidth, and a sub-channel index to indicate a sub-channel bandwidth within the channel. If the sub-channel bandwidth within the channel is not the entire channel, then each resource allocation further includes a sub-channel location to indicate a sub-channel of a plurality of sub-channels of the channel. The method may further include transmitting the one or more resource allocations to the plurality of stations, wherein the one or more resource allocations include a duration, and receiving, in accordance with orthogonal frequency division multiple access (OFDMA) and multi-user multiple-input multiple-output (MU-MIMO), data from the plurality of stations in accordance with the one or more resource allocations.

In Example 16, the subject matter of Example 15 can optionally include, if the sub-channel bandwidth within the channel is not the entire channel, then each sub-channel of the plurality of sub-channels is a multiple of a basic sub-channel size.

In Example 17, the subject matter of Examples 15 or 16 can optionally include where the channel is a 20 MHz portion of the bandwidth, and wherein the bandwidth is one from the following group: 80 MHz, 160 MHz, and 320 MHz, and wherein the sub-channel bandwidth is one from the following group: 26 tones, 52 tones, 104 tones, 242 tones, and 208 tones.

In Example 18, the subject matter of any of Examples 15-17 can optionally include where the resource allocation further comprises an indication of whether there is an additional resource allocation for the station.

In Example 19, the subject matter of any of Examples 15-18 can optionally include where the resource allocation further comprises a ninth sub-channel indication and an additional address of an additional station that is allocated a ninth sub-channel.

Example 20 is a high-efficiency wireless local-area network (HEW) station. The HEW station may include circuitry configured to: receive one or more resource allocations for each station of a plurality of stations. Each resource allocation may include an address of a corresponding station, a channel index to indicate a channel of a plurality of pre-defined channels of a bandwidth, and a sub-channel index to indicate a sub-channel bandwidth within the channel. If the sub-channel bandwidth within the channel is not the entire channel, then each resource allocation may further include a sub-channel location to indicate a sub-channel of a plurality of sub-channels of the channel. The circuitry may be further configured to transmit data to a master station in an uplink transmission opportunity in accordance with orthogonal frequency division multiple access (OFDMA) and multi-user multiple-input multiple-output (MU-MIMO) and in accordance with the one or more resource allocations.

In Example 21, the subject matter of Example 20 can optionally include if the sub-channel bandwidth within the channel is not the entire channel, then each sub-channel of the plurality of sub-channels is a multiple of a basic sub-channel size.

In Example 22, the subject matter of Examples 20 or 21 can optionally include wherein the channel is a 20 MHz portion of the bandwidth, and where the bandwidth is one from the following group: 80 MHz, 160 MHz, and 320 MHz, and where if the sub-channel bandwidth within the channel is not the entire channel, then each sub-channel of the plurality of sub-channels is a multiple of a basic sub-channel size.

In Example 23, the subject matter of any of Examples 20-22 can optionally include memory coupled to circuitry; and one or more antennas coupled to the circuitry.

Example 24 is a non-transitory computer-readable storage medium that stores instructions for execution by one or more processors to perform operations for communication by a high-efficiency wireless local-area network (HEW) master station. The instructions may configure the one or more processors to cause the wireless communication device to generate one or more resource allocations for each station of a plurality of stations. Each resource allocation may include an address of a corresponding station, a channel index to indicate a channel of a plurality of pre-defined channels of a bandwidth, and a sub-channel index to indicate a sub-channel bandwidth within the channel. If the sub-channel bandwidth within the channel is not the entire channel, then each resource allocation may further comprise a sub-channel location to indicate a sub-channel of a plurality of sub-channels of the channel. The instructions may further configure the one or more processors to cause the wireless communications device to transmit the one or more resource allocations to the plurality of stations, where the one or more resource allocations include a duration, and to receive in accordance with orthogonal frequency division multiple access (OFDMA) and multi-user multiple-input multiple-output (MU-MIMO) data from the plurality of stations in accordance with the one or more resource allocations.

In Example 25, the subject matter of Examples 24 can optionally include where the channel is a 20 MHz portion of the bandwidth, and wherein the bandwidth is one from the following group: 80 MHz, 160 MHz, and 320 MHz, and wherein if the sub-channel bandwidth within the channel is not the entire channel, then each sub-channel of the plurality of sub-channels is a multiple of a basic sub-channel size.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A high-efficiency wireless local-area network (HEW) master station, the HEW master device comprising circuitry configured to:
generate one or more resource allocations for each station of a plurality of stations, wherein each resource allocation comprises an address of a corresponding station, a channel index to indicate a channel of a plurality of pre-defined channels of a bandwidth, and a sub-channel index to indicate a sub-channel bandwidth within the channel and wherein, if the sub-channel bandwidth within the channel is not the entire channel, then each resource allocation further comprises a sub-channel location to indicate a sub-channel of a plurality of sub-channels of the channel;
transmit the one or more resource allocations to the plurality of stations, wherein the one or more resource allocations include a duration; and
receive, in accordance with orthogonal frequency division multiple access (OFDMA) and multi-user multiple-input multiple-output (MU-MIMO), data from the plurality of stations in accordance with the one or more resource allocations.

2. The HEW master station of claim 1, wherein the channel is a 20 MHz portion of the bandwidth, and wherein the bandwidth is one from the following group: 80 MHz, 160 MHz, and 320 MHz.

3. The HEW master station of claim 1, wherein the channel index is two bits.

4. The HEW master station of claim 1, wherein the sub-channel bandwidth is one from the following group: 26 tones, 52 tones, 104 tones, 242 tones, and 208 tones.

5. The HEW master station of claim 1, wherein the sub-channel index is two bits to indicate one of four sub-channel bandwidths.

6. The HEW master station of claim 1, wherein, if the sub-channel bandwidth within the channel is not the entire channel, then each sub-channel of the plurality of sub-channels is a multiple of a basic sub-channel size.

7. The HEW master station of claim 6, wherein the basic sub-channel size is 26 tones.

8. The HEW master station of claim 1, wherein the resource allocation further comprises an indication of whether there is an additional resource allocation for the station.

9. The HEW master station of claim 1, wherein the circuitry is further configured to operate in accordance with Institute for Electrical and Electronic Engineers (IEEE) 802.11ax.

10. The HEW master station of claim 1, wherein the one or more resource allocations are for a transmission opportunity.

11. The HEW master station of claim 1, wherein the one or more resource allocations are part of a high efficiency (HE) signal B field.

12. The HEW master station of claim 1, wherein the resource allocation further comprises a ninth sub-channel indication and an additional address of an additional station that is allocated a ninth sub-channel.

13. The HEW master station of claim 1, further comprising memory coupled to circuitry.

14. The HEW master station of claim 14, further comprising one or more antennas coupled to the circuitry.

15. A method on a high-efficiency wireless local-area network (HEW) master device, the method comprising:
generating one or more resource allocations for each station of a plurality of stations, wherein each resource allocation comprises an address of a corresponding station, a channel index to indicate a channel of a plurality of pre-defined channels of a bandwidth, and a sub-channel index to indicate a sub-channel bandwidth within the channel, and wherein, if the sub-channel bandwidth within the channel is not the entire channel, then each resource allocation further comprises a sub-channel location to indicate a sub-channel of a plurality of sub-channels of the channel;
transmitting the one or more resource allocations to the plurality of stations, wherein the one or more resource allocations include a duration; and
receiving, in accordance with orthogonal frequency division multiple access (OFDMA) and multi-user multiple-input multiple-output (MU-MIMO), data from the plurality of stations in accordance with the one or more resource allocations.

16. The method of claim 15, wherein, if the sub-channel bandwidth within the channel is not the entire channel, then each sub-channel of the plurality of sub-channels is a multiple of a basic sub-channel size.

17. The method of claim 15, wherein the channel is a 20 MHz portion of the bandwidth, and wherein the bandwidth is one from the following group: 80 MHz, 160 MHz, and 320 MHz, and wherein the sub-channel bandwidth is one from the following group: 26 tones, 52 tones, 104 tones, 242 tones, and 208 tones.

18. The method of claim 15, wherein the resource allocation further comprises an indication of whether there is an additional resource allocation for the station.

19. The HEW master station of claim 1, wherein the resource allocation further comprises a ninth sub-channel indication and an additional address of an additional station that is allocated a ninth sub-channel.

20. A high-efficiency wireless local-area network (HEW) station, the HEW station comprising circuitry configured to:
receive one or more resource allocations for each station of a plurality of stations, wherein each resource allocation comprises an address of a corresponding station, a channel index to indicate a channel of a plurality of pre-defined channels of a bandwidth, and a sub-channel index to indicate a sub-channel bandwidth within the channel, and wherein, if the sub-channel bandwidth within the channel is not the entire channel, then each resource allocation further comprises a sub-channel location to indicate a sub-channel of a plurality of sub-channels of the channel; and
transmit data to a master station in an uplink transmission opportunity, in accordance with orthogonal frequency division multiple access (OFDMA) and multi-user multiple-input multiple-output (MU-MIMO), and in accordance with the one or more resource allocations.

21. The HEW station of claim 20, wherein, if the sub-channel bandwidth within the channel is not the entire channel, then each sub-channel of the plurality of sub-channels is a multiple of a basic sub-channel size.

22. The HEW station of claim 20, wherein the channel is a 20 MHz portion of the bandwidth, and wherein the bandwidth is one from the following group: 80 MHz, 160 MHz, and 320 MHz, and wherein if the sub-channel bandwidth within the channel is not the entire channel, then each sub-channel of the plurality of sub-channels is a multiple of a basic sub-channel size.

23. The HEW station of claim 20, further comprising: memory coupled to circuitry; and one or more antennas coupled to the circuitry.

24. A non-transitory computer-readable storage medium that stores instructions for execution by one or more processors to perform operations for communication by a high-efficiency wireless local-area network (HEW) master station, the instructions to configure the one or more processors to cause the wireless communication device to:
generate one or more resource allocations for each station of a plurality of stations, wherein each resource allocation comprises an address of a corresponding station, a channel index to indicate a channel of a plurality of pre-defined channels of a bandwidth, and a sub-channel index to indicate a sub-channel bandwidth within the channel, and wherein, if the sub-channel bandwidth within the channel is not the entire channel, then each resource allocation further comprises a sub-channel location to indicate a sub-channel of a plurality of sub-channels of the channel;
transmit the one or more resource allocations to the plurality of stations, wherein the one or more resource allocations include a duration; and
receive, in accordance with orthogonal frequency division multiple access (OFDMA) and multi-user multiple-input multiple-output (MU-MIMO), data from the plurality of stations in accordance with the one or more resource allocations.

25. The non-transitory computer-readable storage medium of claim 24, wherein the channel is a 20 MHz portion of the bandwidth, and wherein the bandwidth is one from the following group: 80 MHz, 160 MHz, and 320 MHz, and wherein if the sub-channel bandwidth within the channel is not the entire channel, then each sub-channel of the plurality of sub-channels is a multiple of a basic sub-channel size.
